(19) United States
(12) Patent Application Publication
(10) Pub. No.: US 2007/0012740 A1
(43) Pub. Date: Jan. 18, 2007

(54) Aerodynamic fluid holder for bicycles

(76) Inventor: Philip Kenneth Montgomery, Victoria (CA)

Correspondence Address: KLARQUIST SPARKMAN, LLP, 121 SW SALMON STREET, SUITE 1600, PORTLAND, OR, 97204, US

(21) Appl. No.: 11/480,104

(22) Filed: Jun. 30, 2006

Related U.S. Application Data
(60) Provisional application No. 60/699,446, filed on Jul. 15, 2005.

(51) Int. Cl. B62J 11/00; B62J 7/06

(52) U.S. Cl. 224/414; 224/420

(57) ABSTRACT

An aerodynamic fluid holder for accepting fluid packs, such as water bottles, for mounting onto a bicycle is provided. According to one embodiment, the fluid holder comprises a first side, a second side, a stern, and a top. The first side can be connected to the second side along a lower edge and along a bow to define a hull. The stern can be connected to the hull at a distal end of the fluid holder and the top can be connected to the stern and the sides to define a cavity. One or more fluid packs can be housed within the cavity. The top has at least one aperture to accept at least one fluid pack.

### CROSS REFERENCE TO RELATED APPLICATION

This application claims the benefit of U.S. provisional patent application Ser. No. 60/699,446, filed Jul. 15, 2005, which is incorporated herein by reference.

### FIELD

The present disclosure relates to holders that are mounted on the handle bars or aerobars of racing bikes. In particular, this disclosure relates to holders that reduce the drag of the bike.

### BACKGROUND

In recent years, significant advances have been made to the design and construction of racing bikes. Design improvements have focused on increasing the aerodynamics of the bikes. Bladed spokes, disc wheels, aerobars or time trial bars and flattened tubes are a few of the improvements that are used. Construction features include the use of lighter alloys and, more recently, carbon fibre frames. While these advances have significantly improved the performance of bikes ranging from criterium to triathlon to time trials bikes, further improvements can be made within the constraints of the racing regulations.

One aspect that has received some attention is the placement of accessories, including water bottle cages and repair kits. With regard to water bottle and water bottle cage placement, there are presently three different locations that are used on racing bikes. Two water bottles are located behind the rider in a holder that attaches to the seat post. This is commonly considered the most aerodynamically efficient. This assumption is based on the belief that the placement behind the rider hides the water bottles from unwanted drag as the rider ‘splits’ the oncoming air and the ensuing turbulence passes beyond the water bottles. The second ‘most efficient’ location is on the handle bar extensions. The third and least aerodynamically efficient location is thought to be the down tube and seat tube water bottle mounts. Recent wind tunnel test data suggests that the above information is incorrect.

John Cobb (aerodynamicist to such notables as Lance Armstrong (seven-time Tour de France winner)) tested all three water bottle locations on time trial bicycles and was surprised by the results. The placement that produced the most drag was the behind the rider placement. It appears the shape of the bicycle tubes coupled with a rider in motion allows for the laminar flow to be pulled back in around the riders back. The behind the rider bottle placement appears to work as a brake. The second surprise was the second best placement for a water bottle on a bike. This was a single bottle attached to the down tube, but must not include an additional bottle on the seat tube, which is the traditional placement for all bicycles. The single seat tube placement approached the efficiency of the placement with the least amount of drag, namely the time trial bar placement.

Although placement of the bottles and cages has been the topic of considerable research, the design and construction of the bottles and cages have not. The bottles are generally cylindrical, with either a straw extending through the top, for easy access during riding, or are a nipple type top. The latter design requires the bottle to be removed from the cage in order for the rider to drink. The bottle holders range from a plastic or aluminum cages to stiff fabrics that accept and hold the bottle.

Products that are available on the market do little to improve upon the aerodynamics of the bicycle and rider. For example, Podium Quest™ markets the PQ Hydration System™, which holds two separate fluids in one container. The container is designed to mount onto the front of a bike on the aerobars. The system is designed so that the triathlete won't break their aero position to reach behind the bike saddle or the bike down tube for water or race fluid. The design took into consideration bike handling, cross winds, weight and size. However, it did not take into consideration the aerodynamics of the container, nor did it take into consideration the potential to improve upon the aerodynamics of the bike and rider through the design and placement of the container. The container must be slid in between the aerobars and then attached to the aerobars with Velcro closures. As can be seen in the prior art FIG. 1, the container is located a distance in front of the handlebars and therefore, a distance in front of the brake and gear cables. In this location, there is a tendency for turbulence to develop between the container and the bike and rider. Further to this, the shape of the container requires that the container be mounted partially above the aerobars. In this location, it is contributing to drag and turbulence. Turbulence would also be expected to develop around the Velcro™ and foam that are used to attach the container to the bike. Further to this, the fact that the container has to be slid between the aerobars means that the bars must not be the single unit design—there must be two bars so that there is an open end distal to the bike. Perhaps of equal significance, the space between the bars must be controlled by the size of the container rather than the size of the rider. The fact that the container is shaped to be accepted by aerobars restricts its usage to either time trials or triathlons. In other bike races, such as criteriums and road races, aerobars are not permitted. Hence, the PQ system has limited applicability to the sport of bike racing.

Hence, there is room for improvement over the prior art.

### SUMMARY

An aerodynamic fluid holder for accepting fluid packs, such as water bottles or containers, for mounting onto a bicycle is disclosed. The fluid holder in an exemplary embodiment comprises a first side, a second side, a stern, and a top. The first side is connected to the second side along a lower edge and along a bow to define a hull. The stern is connected to the hull at a distal end of the fluid holder and the top is connected to the stern and the sides to define a cavity. One or more fluid packs can be housed within the cavity. The top has at least one aperture to accept at least one fluid pack.

In one embodiment of the fluid holder the hull has a soft chine.

In one aspect, the top has two apertures.

In another aspect, the fluid holder further comprises a lid for each aperture.

In another aspect, the lids comprise a first opening and a second opening, the first opening to accept a straw and the second opening to accept fluid.

In one aspect, the hull comprises a unit body construction.

In another aspect, the stern and hull comprise a unit body construction.

In another aspect, the stern and hull comprise molded plastic polymer.

In another aspect, the first and said second sides are affixed to one another along a lower edge and along the bow to form the hull.

In another aspect, the stern is affixed to a proximal end of the fluid holder.

In another aspect, the holder comprises carbon fibre.

In another embodiment, the hull has a hard chine.

In another aspect the invention further comprises a nutrition sack.

In another aspect, the nutrition sack is mounted on the stern of the fluid holder.

In another aspect, the maximum width of the hull ranges from about 100-250 mm, the total height of the hull ranges from about 150-200 mm, and the length of the hull ranges from about 150-250 mm.

In another aspect, the maximum width of the hull ranges from about 100-230 mm, the total height of the hull ranges from about 170-200 mm, and the length of the hull ranges from about 170-230 mm.

In another aspect, the maximum width of the hull ranges from about 100-190 mm, the total height of the hull ranges from about 170-190 mm, and the length of the hull ranges from about 170-190 mm.

In another aspect, fasteners can be used to fasten the fluid holder to the bike.

In another aspect, the fasteners are clamps.

In another embodiment, a method of improving the aerodynamics of a bicycle is provided. The method comprises mounting a fluid holder comprising a hull, a stern, a top and fasteners, onto the bicycle in a location in front of the cockpit of the bicycle, wherein the maximum width of the hull ranges from about 100-250 mm, the total height of the hull ranges from about 150-200 mm, and the length of the hull ranges from about 150-250 mm.

In another aspect, the method comprises mounting a fluid holder comprising a hull, a stern, a top and fasteners, onto the bicycle in a location in front of the cockpit of the bicycle, wherein the maximum width of the hull ranges from about 100-230 mm, the total height of the hull ranges from about 170-200 mm, and the length of the hull ranges from about 170-230 mm.

In another aspect, the method comprises mounting a fluid holder comprising a hull, a stern, a top and fasteners, onto the bicycle in a location in front of the cockpit of the bicycle, wherein the maximum width of the hull ranges from about 100-190 mm, the total height of the hull ranges from about 170-190 mm, and the length of the hull ranges from about 170-190 mm.

The foregoing and other features and advantages of the invention will become more apparent from the following detailed description, which proceeds with reference to the accompanying figures.

### BRIEF DESCRIPTION OF THE DRAWINGS

FIG. 1 is a side view of a prior art container shown mounted on a bicycle.

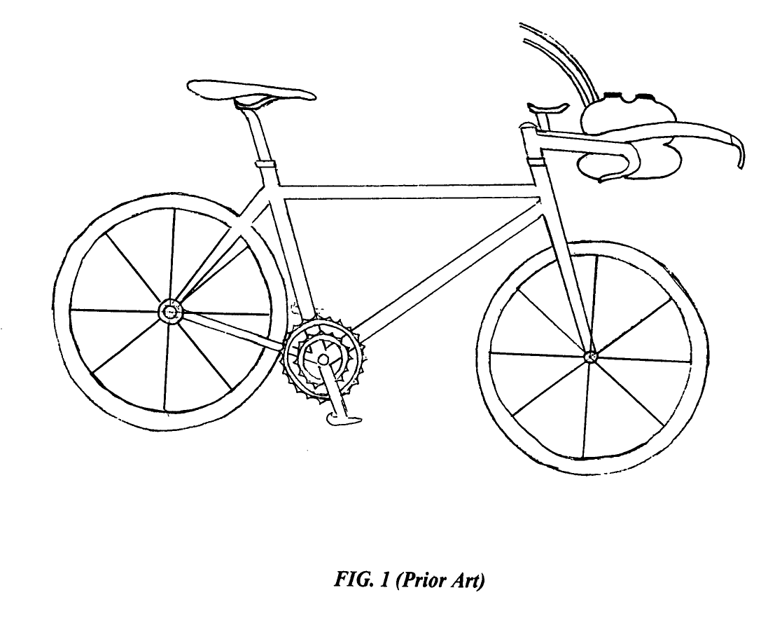

FIG. 2 is a side view of an aerodynamic fluid holder mounted on a bicycle in accordance with an embodiment.

FIG. 3 is a top view of the aerodynamic fluid holder of FIG. 2 mounted on a bicycle.

FIG. 4 is top view of the aerodynamic fluid holder of FIG. 2, showing the aperture and the aperture with the lid closure in place.

FIG. 5 is a sectional view taken along line 5-5 in FIG. 4 of the aerodynamic fluid holder of FIG. 2.

FIG. 6 is a back view of the aerodynamic fluid holder of FIG. 2.

FIG. 7 is a back view of the aerodynamic fluid holder of FIG. 2 showing dimensions of a specific embodiment.

FIG. 8 is a top view of the aerodynamic fluid holder of FIG. 2 showing dimensions of a specific embodiment.

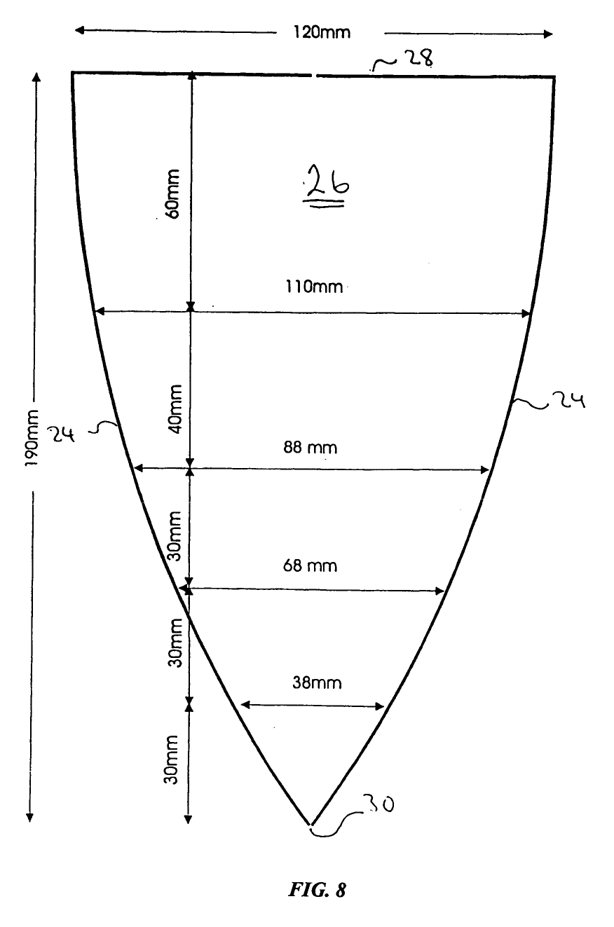

### DETAILED DESCRIPTION

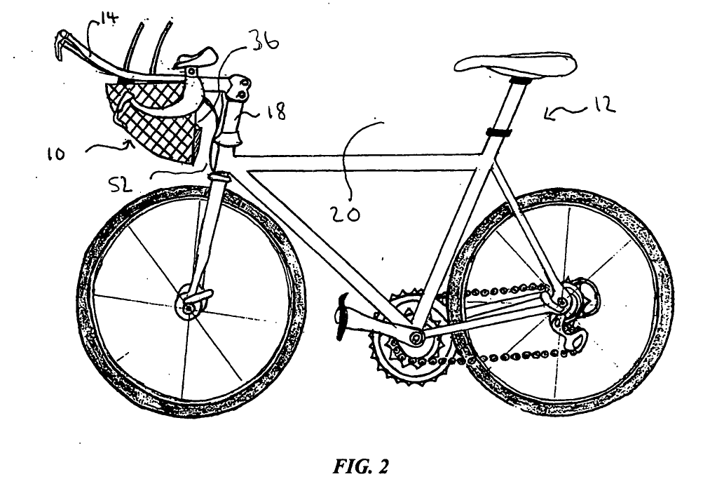

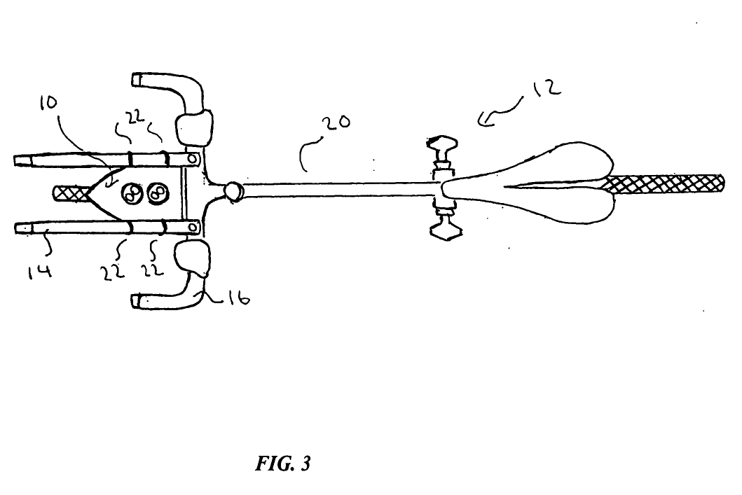

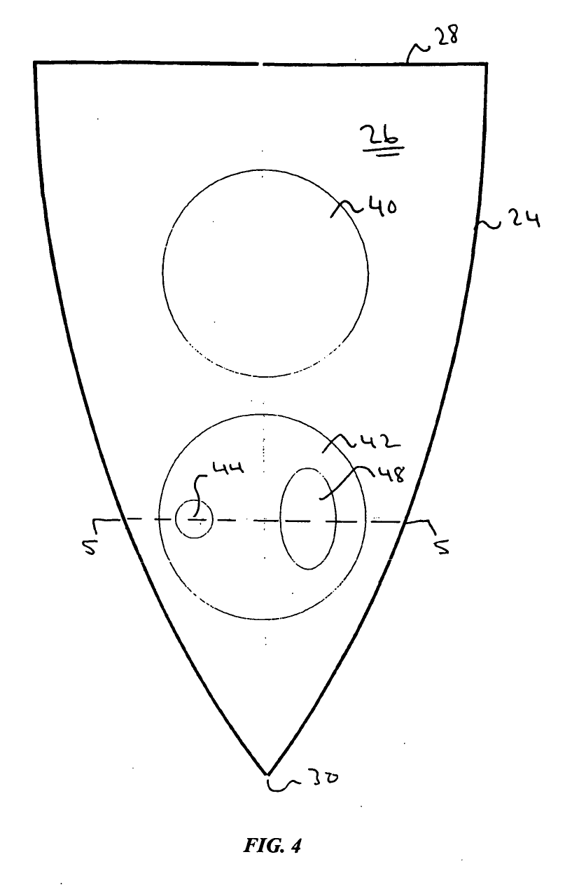

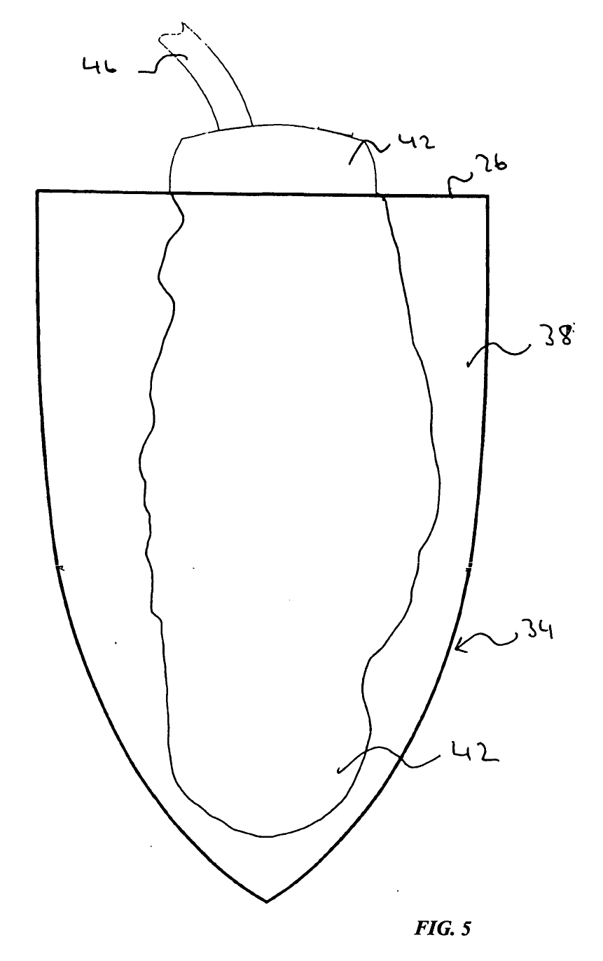

A fluid holder, generally referred to as 10, is mounted on a bicycle 12 as shown in FIGS. 2 and 3. The fluid holder 10 can be mounted either to aerobars 14, as shown, or can be attached to standard handle bars 16 or to the head set tube 18, or other such locations in the front of the cockpit 20 of the bike 12, such as by means of fasteners 22. The fluid holder 10 has two sides 24, a top 26 and a stern 28, as shown in FIG. 4. The two sides 24 are configured to reduce drag, hence they desirably abut one another at a bow 30 and along a lower edge 32, to form a hull, generally referred to as 34. The stern 28 is affixed to the hull 34 at a proximal end 36 of the fluid holder. The top 26 is affixed to an upper edge 37 of the hull 34 and stern 28. Hence the hull 34, stern 28 and top 26 form a cavity 38. The top 26 in the illustrated embodiment has two apertures 40 to accept fluid packs 42, which can be, for example, plastic polymer bags. The apertures 40 can have lid closures 42, each with a first opening 44 to accept a straw 46 and a second opening 48 to facilitate refilling on the fly. The fluid packs 42 can be placed in the cavity 38 through the apertures 40, as shown in FIG. 5. The back 28 can further comprise a nutrition sack 50 that accepts nutrition packs. The fluid holder 10 in an exemplary embodiment is constructed from carbon fiber. Its total dry weight is approximately 250 grams.

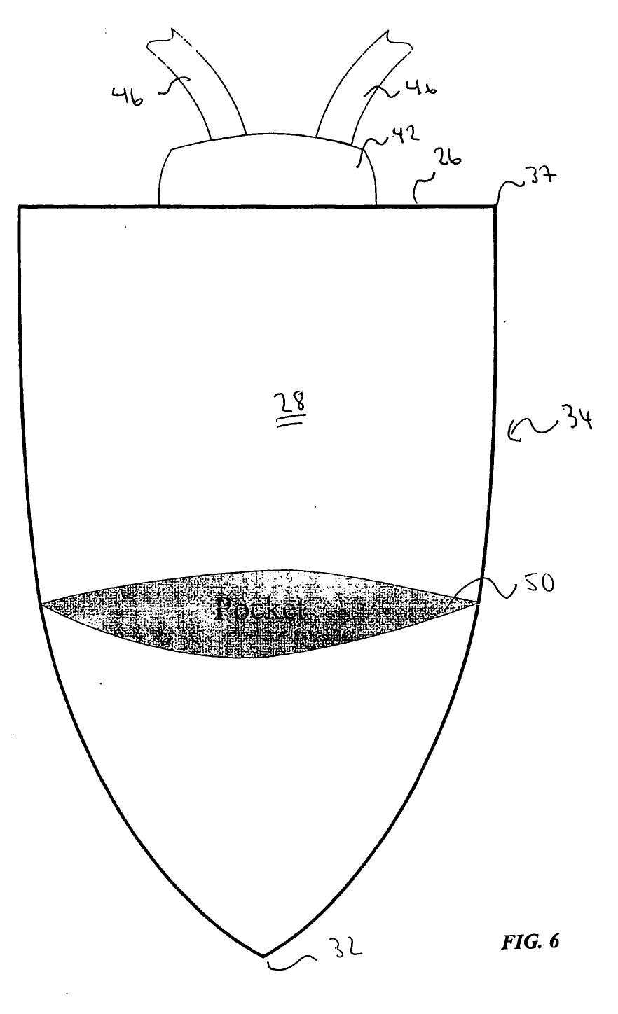

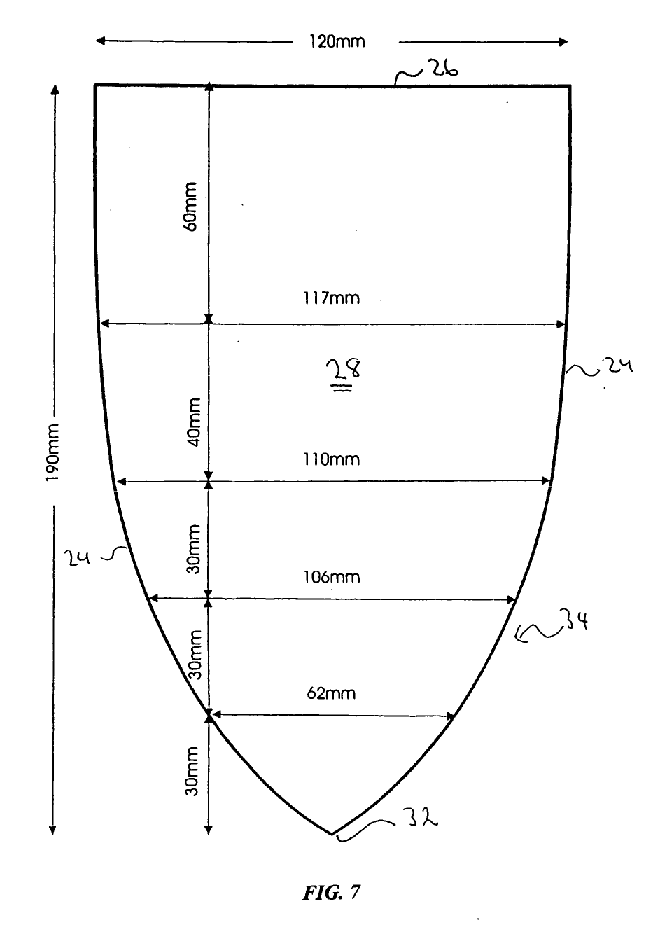

The dimensions of the hull 34 and the top 26 in an exemplary embodiment are shown in FIGS. 6 and 7, respectively. In one embodiment the hull 34 has a soft chine, as shown in FIG. 6. In another embodiment, the hull 34 has a hard chine.

The fluid holder 10 is designed to ‘hide’ the drag caused by cable housings 52 and the head set tube 18 when a bike 12 is in motion. The International Triathlon Union (UTI) does not allow for an aerodynamic fairing to be used during competition, but they do allow for aerodynamically shaped water bottles to be attached to time trial handle bar extensions. The illustrated fluid holder 10 complies with the rule and dimension constraints specified by the ITU.

The foregoing is a description of an embodiment of the invention. As would be known to one skilled in the art, variations that do not alter the scope of the invention are contemplated. For example, the hull can be soft or hard chine, the fluid packs may be water bottles, bags, or any fluid container that can be accepted by the fluid holder, and the holder can be single unit construction, such as a molded plastic polymer or may be formed from individual components. The components may be fused together, for example, by plastic welding or may be affixed to one another by tapes or other forms of adhesive. The dimensions cited are an example of a workable shape, and variation about the dimensions are anticipated. For example, the maximum width of the hull can range from about 100-250 mm, the total height of the hull can range from about 150-200 mm, and the length of the hull can be about 150-250 mm. Also, various means of attaching the fluid holder to the bike are contemplated, including zip type ties, wire Velcro™, adhesives or clamps. Also, the fasteners can be located to permit attaching the fluid holder to conventional handlebars, drop bars, aerobars, stern or head set tube, for example.

Accordingly, the scope of the invention is defined by the following claims. I therefore claim as my invention all that comes within the scope and spirit of these claims.

I claim:

1. An aerodynamic fluid holder for accepting one or more fluid packs for mounting onto a bicycle, said fluid holder comprising:
a first side, a second side, a stern, and a top;
said first side connected to said second side along a lower edge and along a bow to define a hull;
said stern connected to said hull at a distal end of said fluid holder;
said top connected to said stern and said sides to define a cavity; and
said top having at least one aperture to accept at least one fluid pack.

2. The fluid holder of claim 1 wherein said hull has a soft chine.

3. The fluid holder of claim 2 wherein said top has two apertures.

4. The fluid holder of claim 3, further comprising a lid for each aperture.

5. The fluid holder of claim 4 wherein said lids comprise a first opening and a second opening, said first opening to accept a straw and said second opening to accept fluid.

6. The fluid holder of claim 5, wherein said hull comprises a unit body construction.

7. The fluid holder of claim 6 wherein said stern and hull comprise a unit body construction.

8. The fluid holder of claim 7 wherein said stern and hull comprise molded plastic polymer.

9. The fluid holder of claim 5 wherein said first and said second sides are affixed to one another along a lower edge and along said bow to form said hull.

10. The fluid holder of claim 9 wherein said stern is affixed to a proximal end of said fluid holder.

11. The fluid holder of claim 10 wherein said holder comprises carbon fibre.

12. The fluid holder of claim 11 wherein said hull has a hard chine.

13. The fluid holder of claim 1 further comprising a nutrition sack.

14. The fluid holder of claim 13 wherein said nutrition sack is mounted onto said stern of said fluid holder.

15. The fluid holder of claim 1, wherein the maximum width of the hull ranges from about 100-250 mm, the total height of the hull ranges from about 150-200 mm, and the length of the hull ranges from about 150-250 mm.

16. The fluid holder of claim 15 wherein the maximum width of the hull ranges from about 100-230 mm, the total height of the hull ranges from about 170-200 mm, and the length of the hull ranges from about 170-230 mm.

17. The fluid holder of claim 16 wherein the maximum width of the hull ranges from about 100-190 mm, the total height of the hull ranges from about 170-190 mm, and the length of the hull ranges from about 170-190 mm.

18. The fluid holder of claim 1 further comprising fasteners for fastening said fluid holder to the bike.

19. The fluid holder of claim 18 wherein said fasteners are clamps.

20. A method of improving the aerodynamics of a bicycle, said method comprising mounting a fluid holder comprising a hull, a stern, a top and fasteners, onto said bicycle in a location in front of the cockpit of said bicycle, wherein the maximum width of the hull ranges from about 100-250 mm, the total height of the hull ranges from about 150- 200 mm, and the length of the hull ranges from about 150-250 mm.

21. The method of claim 20 wherein said method comprises mounting a fluid holder comprising a hull, a stern, a top and fasteners, onto said bicycle in a location in front of the cockpit of said bicycle, wherein the maximum width of the hull ranges from about 100-230 mm, the total height of the hull ranges from about 170-200 mm, and the length of the hull ranges from about 170-230 mm.

22. The method of claim 21 said method comprises mounting a fluid holder comprising a hull, a stern, a top and fasteners, onto said bicycle in a location in front of the cockpit of said bicycle, wherein the maximum width of the hull ranges from about 100-190 mm, the total height of the hull ranges from about 170-190 mm, and the length of the hull ranges from about 170-190 mm.
